(19) United States
(12) Patent Application Publication
(10) Pub. No.: US 2015/0257586 A1
(43) Pub. Date: Sep. 17, 2015

(54) SINGLE-SERVE BEVERAGE PRODUCTION MACHINE

(71) Applicant: Starbucks Corporation dba Starbucks Coffee Company, Seattle, WA (US)

(72) Inventors: Darcy A. DiNucci, Vallejo, CA (US); Michael McQueen, San Francisco, CA (US); Hamish S. Thain, San Francisco, CA (US); Adam Mekeel Mack, Menlo Park, CA (US); Alexander Kwok Yin Ko, San Francisco, CA (US); Jonathan Krakower, Moss Beach, CA (US)

(73) Assignee: Starbucks Corporation dba Starbucks Coffee Company, Seattle, WA (US)

(21) Appl. No.: 14/205,198

(22) Filed: Mar. 11, 2014

(51) Int. Cl. A47J 31/44; A47J 31/40

(52) U.S. Cl. CPC A47J 31/4492; A47J 31/407

(57) ABSTRACT

A single-serve beverage preparation device including a multi-chambered basket unit having a first cartridge-receiving chamber and a second cartridge-receiving chamber is provided. The first cartridge-receiving chamber is configured to receive a first cartridge of a first beverage type and the second cartridge-receiving chamber is configured to receive a second cartridge of a second beverage type. The device includes a reader configured to read a code or tag associated with a single-serve beverage cartridge containing one or more beverage ingredients. The device can include a controller configured to determine a beverage type of the single-serve beverage cartridge from the code or tag and to cause the multi-chambered basket unit to present the cartridge-receiving chamber corresponding to the determined beverage type in a position to receive a single-serve beverage cartridge.

### RELATED APPLICATIONS

This application is related to at least U.S. application Ser. No. ______, titled “BEVERAGE PRODUCTION MACHINES AND METHODS WITH MULTI-CHAMBERED BASKET UNITS,” which is filed on the same day as the present application and is Attorney Reference No. SBUX1.295A; U.S. application Ser. No. ______, titled “CARTRIDGE EJECTION SYSTEMS AND METHODS FOR SINGLE-SERVE BEVERAGE PRODUCTION MACHINES,” which is filed on the same day as the present application and is Attorney Reference No. SBUX1.297A1; U.S. application Ser. No. ______, titled “BEVERAGE PRODUCTION MACHINES AND METHODS WITH TAMPING ASSEMBLY,” which is filed on the same day as the present application and is Attorney Reference No. SBUX1.306A; U.S. application Ser. No. ______, titled “BEVERAGE PRODUCTION MACHINES AND METHODS WITH RESTRICTORS,” which is filed on the same day as the present application and is Attorney Reference No. SBUX1.332A; and U.S. application Ser. No. ______, titled “POD-BASED RESTRICTORS AND METHODS,” which is filed on the same day as the present application and is Attorney Reference No. SBUX1.333A. The entirety of each of the aforementioned applications is hereby incorporated herein by reference.

### FIELD

The present disclosure generally relates to apparatus, systems, and methods for preparing, or producing, a beverage, such as coffee or tea, and includes the disclosure of automated single-cup beverage systems.

### BACKGROUND

Many methods and systems for brewing beverages, such as coffee and tea, are known. In conventional beverage brewing systems, a brewing machine typically brews a relatively large batch of the beverage. In commercial settings, a barista may pour cup- or individual-sized portions from the batch when a customer places an order. Such beverage brewing systems can be inefficient because the beverage may be wasted when not all of the beverage in the batch is ordered or consumed. In addition, such systems may produce a beverage having an inconsistent flavor and taste because the beverage is not necessarily brewed when a customer places an order and may not be fresh when consumed.

Automated single-cup coffee brewing systems may be employed to address some of the disadvantages of conventional batch-type coffee brewing systems. Users of automated single-cup coffee brewing systems may benefit from several improvements to those systems, including, but not limited to, reducing the time it takes to brew a single-cup portion or traveler portion of a beverage, reducing the labor and time involved in cleaning brewing equipment between brew cycles, reducing steam and condensation from entering the grinder and hopper areas of the system to improve the quality of the beverage and to reduce corrosion on grinder components, improving the accuracy and repeatability of providing a desired dose of ingredients to a grinder portion of the system, improving agitation of ingredients during a brew cycle, and reducing the labor and time involved in maintaining the hoppers and refilling the hoppers with ingredients.

### BRIEF DESCRIPTION OF THE DRAWINGS

The features of embodiments of the inventions will become more readily appreciated as the same become better understood by reference to the following detailed description, when taken in conjunction with the accompanying drawings, wherein:

FIG. 1 is a perspective view of an illustrative embodiment of a beverage preparation device.

FIG. 2 is a perspective view of a lid portion of the beverage preparation device of FIG. 1.

FIG. 3 is a cross-section view illustrating internal components of an embodiment of a reader assembly of the beverage preparation device of FIG. 1.

FIGS. 4A-4C illustrate an embodiment of a user interface of the beverage preparation device of FIG. 1.

FIGS. 5A and 5B illustrate embodiments of packaging for single-serve cartridges to be used with the beverage preparation device of FIG. 1.

FIG. 6A illustrates an example encoding implementation.

FIG. 6B illustrates an embodiment of a look-up table stored in memory of the beverage preparation device of FIG. 1.

FIGS. 7A-7C illustrate embodiments of a multi-chambered basket assembly of the beverage preparation device of FIG. 1.

FIG. 8 is a control diagram illustrating overall operation of the beverage preparation device of FIG. 1.

FIG. 9 is a control diagram illustrating states involved in preparation of a single-serve brewed beverage by the beverage preparation device of FIG. 1.

FIG. 10 is a control diagram illustrating states involved in preparation of a single-serve tea beverage by the beverage preparation device of FIG. 1.

FIG. 11 is a block system diagram illustrating an embodiment of a beverage preparation system.

Throughout the drawings, reference numbers are re-used to indicate correspondence between referenced elements. The drawings are provided to illustrate embodiments of the inventions described herein and not to limit the scope thereof.

### DETAILED DESCRIPTION

The following discussion is presented to enable a person skilled in the art to make and use one or more of the present embodiments. The general principles described herein may be applied to embodiments and applications other than those detailed below without departing from the spirit and scope of the disclosure. Therefore, the present embodiments are not intended to be limited to the particular embodiments shown, but are to be accorded the widest scope consistent with the principles and features disclosed or suggested herein.

Various beverage production, or preparation, machines, code or tag readers and brew assemblies are described below to illustrate various examples that may be employed to achieve one or more desired improvements. These examples are only illustrative and not intended in any way to restrict the general disclosure presented and the various aspects and features of the disclosure. Certain aspects, advantages, and features of the inventions have been described herein. It is not necessary that any or all such aspects, advantages, and features are achieved in accordance with any particular embodiment. Indeed, not all embodiments achieve the advantages described herein, but may achieve different advantages instead. Any structure, feature, or step in one example is contemplated to be used in place of or in addition to any structure, feature, or element of any other example. No features, structure, or element disclosed herein is essential or indispensable.

### I. Introduction

Generally described, embodiments of the present disclosure relate to beverage production, or preparation, devices or machines that are capable of producing, or preparing, a single-serve portion of a beverage from a cartridge based on a specific recipe determined by a processor or controller from an information element such as a tag (e.g., radiofrequency identification (RFID) tag or near field communication (NFC) tag) or machine-readable code (e.g., optical code, one dimensional (1D) bar code, two dimensional (2D) bar code, etc.) associated with the cartridge. The information element (e.g., bar or code) may be located on packaging independent of the cartridge or located on the cartridge itself. The beverage preparation devices or machines may be capable of preparing automated single-serve portions of brewed coffee, espresso, tea, hot cocoa or other beverages. The beverages may include hot beverages or cold beverages.

As one example, multiple single-serve beverage cartridges may be provided within a packaging assembly (e.g., a box or bag). The packaging may include a 2D bar code (also referred to as a “matrix code”), examples of which include, but are not limited to, a QR® or “quick response” code, an EZCode® bar code, a PDF417 or “portable data file” bar code, a high capacity color bar code, etc., that encodes a specific recipe for preparation of a beverage from the single-serve beverage cartridges. In one embodiment, the 2D code from the packaging can be positioned near a scanning or reading area of the beverage preparation machine and the 2D code can be read or scanned by the beverage preparation machine and decoded to determine the recipe for automatically preparing a single-serve beverage. The 2D code may include, for example, beverage type, temperature, time or other recipe components or instructions, including instructions for preparing multiple single-serve beverage cartridges (e.g., a coffee cartridge followed by a beverage cartridge).

In some embodiments, the beverage preparation machine includes a multi-chambered basket unit or multiple separate baskets configured to receive cartridges of different beverage types (for example, brewed coffee, espresso coffee, tea) and the selection of which chamber or basket to use to prepare the beverage is determined from the 2D code. The different chambers or baskets may have different sizes, shapes, structural features, and/or materials. For example, a first chamber or basket may be configured to receive and prepare a cartridge for a first type of beverage, such as brewed coffee, and a second chamber or basket may be configured to receive and prepare a cartridge for a second type of beverage, such as espresso coffee. The brewed coffee chamber may include structural features such as filtration elements, strainers, large exit apertures, etc. configured to facilitate brewing of coffee grounds. The espresso coffee chamber may be smaller in size than the brewed coffee chamber and may include structural features configured to prepare the espresso beverage at a higher pressure than the brewed coffee beverage (for example, the espresso coffee chamber may include very small exit apertures or may be configured to receive a tamp that compresses the grounds in the cartridge). The cartridges to be received in each such respective chambers may also include different structural features to facilitate preparation of different types of beverages. For example, a cartridge for use in preparing an espresso or other high pressure type beverage may be configured may to withstand a higher pressure being applied to its contents, rather than a cartridge used for preparing a brewed type coffee or other low pressure type beverage, in order to prepare an espresso beverage rather than a brewed coffee beverage. Thus, an espresso or “high pressure” cartridge may include a stretchable lid (for receiving a tamp that compresses the grounds in the cartridge), may include smaller exit apertures, or may be smaller in size, while a brewed coffee or “low pressure” cartridge may include larger or more exit apertures, may include a non-deformable or stretchable lid, or may be larger in size. In various embodiments, “low pressure” cartridges may be configured to be prepared in a low pressure chamber or basket at a pressure of less than 5 psi (0.345 bar) or less than 1 bar and “high pressure” cartridges may be configured to be prepared in a high pressure chamber or basket at a pressure of greater than 5 bar (e.g., about 9 bar (130.5 psi), greater than 9 bar, greater than 10 bar, within a range of 9 bar-20 bar).

In accordance with several embodiments, a device (e.g., a beverage production, or preparation, device) includes a first cartridge-receiving chamber and a second cartridge-receiving chamber. The first cartridge-receiving chamber may be constructed or designed to receive a first cartridge of a first type and the second cartridge-receiving chamber may be constructed or designed to receive a second cartridge of a second type. The first type of cartridge may be a low pressure cartridge (e.g., brewed coffee cartridge) and the second type of cartridge may be a high pressure cartridge (e.g., espresso cartridge). The first cartridge-receiving chamber may have a first size and the second cartridge-receiving chamber may have a second size smaller than the first size.

The device may include a code reader (e.g., a machine-readable code reader or a bar code reader) that can read a code (e.g., 1D code or 2D code) associated with an insertable cartridge (e.g., a single-serve beverage cartridge) containing one or more ingredients. The code may be located on the packaging of the cartridge in which the cartridge is packaged or on a portion of the external surface of the cartridge.

The device may include a controller to determine a type of the insertable cartridge from code. In some implementations, if the controller determines from the code that the type of the insertable cartridge is a first type, the controller causes the first cartridge-receiving chamber to be presented to receive the insertable cartridge and, if the controller determines from the code that the type of the insertable cartridge is a second type, the controller causes the second cartridge-receiving chamber to be presented to receive the insertable cartridge. In some implementations, a multi-chambered basket unit may present the appropriate cartridge-receiving chamber by rotating about an axle (e.g., a central axle).

In accordance with several embodiments, a method of preparing beverages of a first beverage type and a second beverage type using a beverage preparation machine includes reading an information element (e.g., a machine-readable code, an RFID tag, an NFC tag) associated with a first beverage cartridge of a first beverage type. In some implementations, the method includes determining the first beverage type from the information element. In response to determining the first beverage type from the information element, the method may include causing a first cartridge-receiving chamber of a multi-chambered basket unit to be presented in a position to receive the first beverage cartridge of the first beverage type from a user of the beverage preparation machine and preparing a first beverage using the first beverage cartridge.

The method may further include reading an information element (e.g., a machine-readable code, an RFID tag, an NFC tag) associated with a second beverage cartridge of a second beverage type and determining the second beverage type from the information element. In response to determining the second beverage type from the machine readable code, the method may include causing a second cartridge-receiving chamber of a multi-chambered basket unit to be presented in a position to receive the second beverage cartridge of the second beverage type from the user and preparing a second beverage using the second beverage cartridge. In some implementations, determining the first beverage type from a bar code includes accessing a look-up table based on an alphanumeric character determined from the bar code.

### II. Beverage Preparation Machine

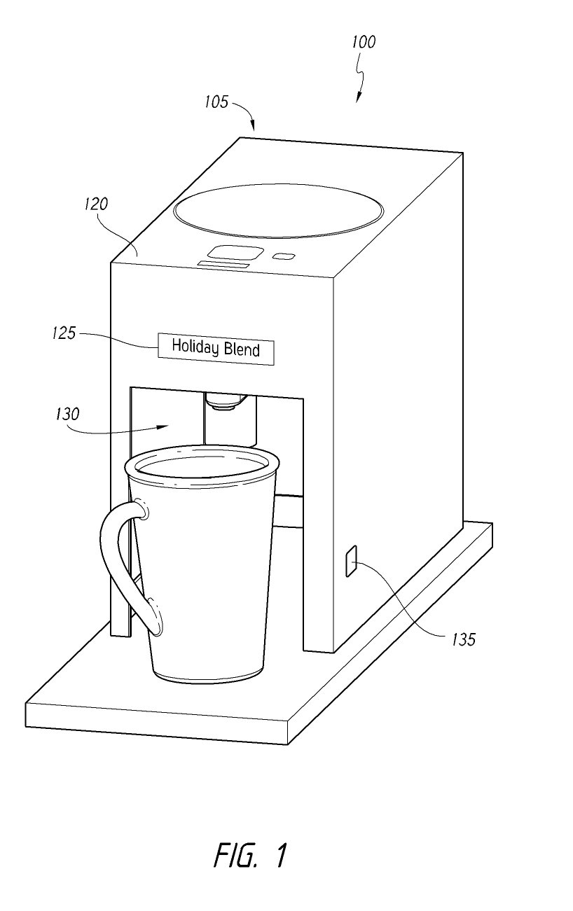

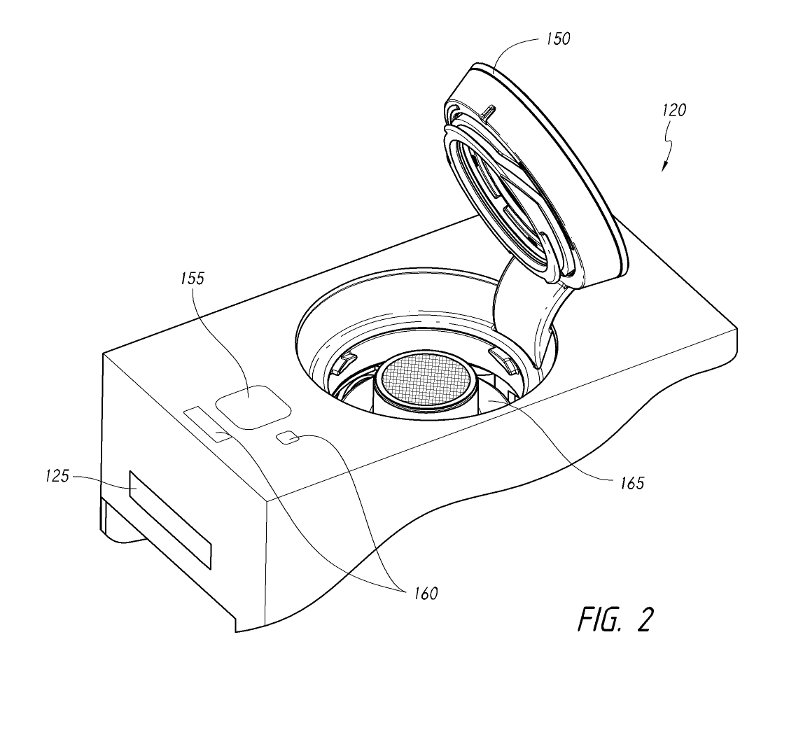

FIG. 1 illustrates a perspective view of an illustrative embodiment of a beverage preparation machine or device 100. The beverage preparation machine 100 may include a main housing 105. The main housing 105 may include a lid portion 120, a display portion 125, and a dispensing portion 130. The lid portion 120 is illustrated in further detail in FIG. 2. In some embodiments, one or more of the components of the beverage preparation machine 100 are housed on and/or partially in a tray. The main housing 105 may also include a main power input 135 (e.g., a button, touchscreen or switch).

The display portion 125 can be configured to display user instructions, status updates, beverage information, or other information. The display can include textual and/or graphical display features on a display screen behind a window. In one embodiment, the display portion 125 includes a dead front display module. The dead front display module may include a liquid crystal display (LCD) or a light emitting diode (LED) display. In one embodiment, the LCD display is an ultra high contrast negative LCD display. In another embodiment, the LED display is an organic LED (OLED) display. The display may incorporate white text through a black dead front window. Other color texts can also be used as desired. In one embodiment, a window covering a display screen may be clear and the text may be dark (e.g., black). The display may be configured to be illuminated when active and dark when inactive. The window may be adhered to the chassis of the main housing 105 by high strength bonding adhesive tape or other adhesive. In some embodiments, the adhesive doubles as a gasket around the display module, thereby protecting the module from steam and heat from a hot beverage being dispensed below the display.

The dispensing portion 130 is configured to receive a receptacle or container 101 (e.g., cup or mug) into which a single-serve beverage portion can be dispensed. In some embodiments, the dispensing portion 130 includes an adjustable stand that can be raised or lowered depending on the size of the receptacle or container 101. The dispensing portion 130 may also include an outlet nozzle configured to dispense the prepared beverage into the receptacle or container 101. In some implementations, the dispensing portion may include a spill chamber configured to collect any beverage dripping from the outlet nozzle and not into a receptacle or container.

A liquid reservoir can be in fluid communication (e.g., via tubing or pipes) with the main housing 105 to provide liquid (e.g., water) stored within the liquid reservoir to a beverage preparation chamber within the main housing 105 where the beverage is prepared. In some embodiments, the liquid reservoir is a component of and/or is within the main housing 105. In other embodiments, the liquid reservoir is external to and/or non-integral with the main housing 105. In various embodiments, the liquid is pre-heated before entering the beverage preparation chamber. For example, the liquid may be heated within a separate storage reservoir or within fluid supply lines as the liquid travels to the beverage preparation chamber. The amount of liquid (e.g., water) provided to the beverage preparation chamber from the liquid reservoir may be determined by the beverage recipe. The liquid reservoir may include a water level sensor configured to determine whether enough liquid is present in the liquid reservoir to prepare a requested beverage.

The beverage preparation machine 100 may also include a frother unit configured to cause beverage liquid to be dispensed with a froth of bubbles (e.g., frothed milk). After dispensing a brewed beverage into the receptacle or container 101, the frothed liquid (e.g., frothed milk) can be poured into the beverage. The frother unit may include a control input (e.g., a user-actuated button) to toggle on and off the frother unit.

Turning to FIG. 2, the lid portion 120 may include a lid 150, a reader 155, and one or more user-actuatable buttons 160. When the lid 150 is open, a single-serve beverage cartridge may be inserted into a beverage preparation chamber 165. In some embodiments, the lid 150 only opens after a code or tag is scanned or read by the reader 155 of the beverage preparation machine 100, e.g., from packaging in which the cartridge is contained or from the cartridge itself. In one embodiment, the lid 150 is opened automatically. In another embodiment, the lid 150 is opened manually. As will be described in further detail below, the beverage preparation machine 100 may include a multi-chambered basket unit (e.g., a double-sided brew basket) or multiple separate baskets to allow for preparation of different beverage types using a single machine. The basket presented to the beverage preparation chamber 165 to receive the single-serve cartridge may be selected or determined based on the code or tag read by the reader 155.

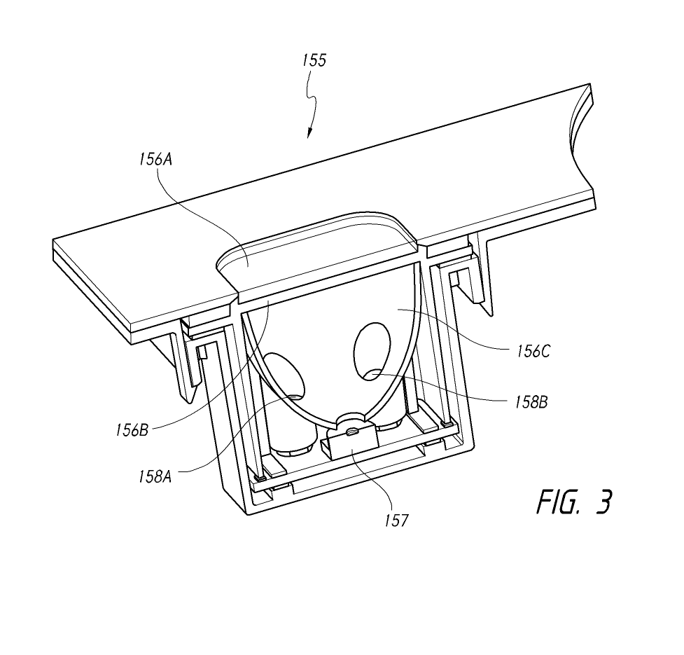

With reference to FIG. 3, a cross-section view of an embodiment of the reader 155 is illustrated. In the illustrated embodiment, the reader 155 includes a stack-up window assembly 156, a camera module 157 and multiple flash sources 158. The stack-up window assembly 156 includes three layers: an outer clear acrylic layer 156A, a middle optically clear adhesive (OCA) layer 156B, and an inner infrared glass layer 156C; however, other assemblies comprised of one, two, three, four or more layers and/or of different materials may be used. In one embodiment, the flash sources 158 are light emitting diodes (LEDs). The LEDs may be infrared LEDs or visible light LEDs. The reader 155 illustrated in FIG. 3 may advantageously be configured to read or scan machine readable codes, such as Quick Response codes, Universal Product (UPC) codes or other bar codes. In other embodiments, the reader 155 is an RFID reader configured to interrogate RFID tags or NFC tags. The reader 155 may alternatively be configured to “read” other information-storing and transferring mechanisms. In one embodiment, the reader 155 is configured to determine beverage type based on color or shape, or alphanumeric text or symbols. As shown in FIG. 3, the outer layer of the stack-up window assembly 156 may be flush or substantially flush with the outer surface of the lid 150.

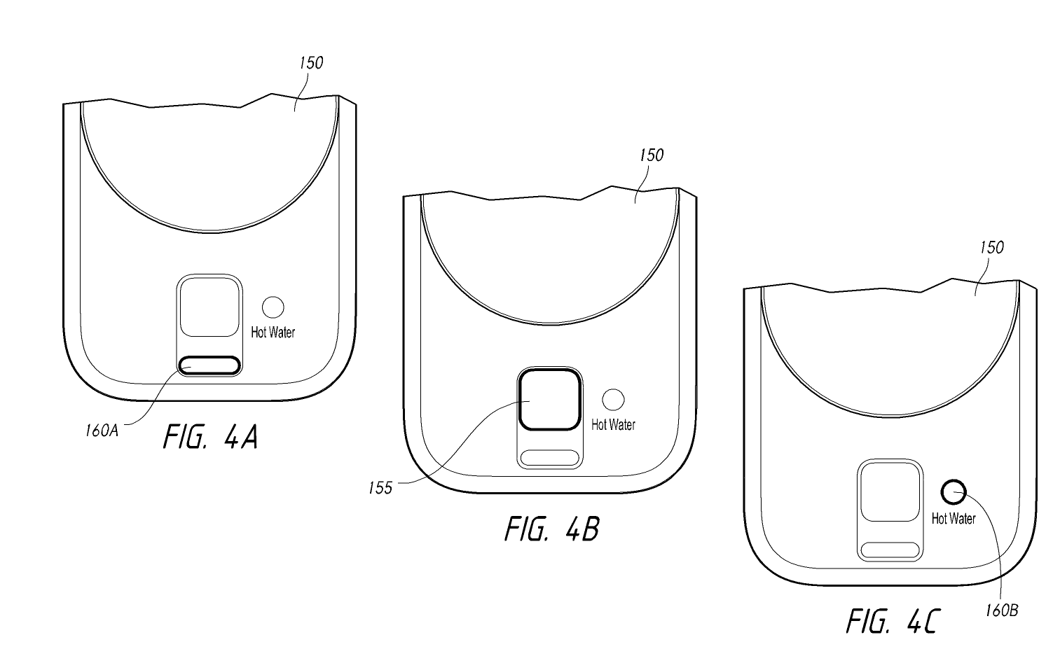

Turning to FIGS. 4A-4C, the reader 155 and the user-actuatable buttons 160 may be illuminated to provide operational indications to a user to help the user know how to operate the beverage preparation machine 100 at different stages of operation. The user-actuatable buttons 160 may include a start button 160A and a hot water button 160B. The start button 160A may be configured to initiate the beverage preparation process after a code or tag has been read by the reader 155. The hot water button 160B may be pressed to dispense hot water 160B (either to add additional hot water after the beverage has been initially prepared or to dispense hot water independent of beverage preparation by the machine). In some embodiments, the hot water button 160B is pressed continuously to dispense the desired amount of hot water. In other embodiments, the hot water button 160B is pressed and released quickly to dispense a predetermined quantity of hot water. In still other embodiments, multiple hot water buttons may be present to dispense differing quantities of hot water.

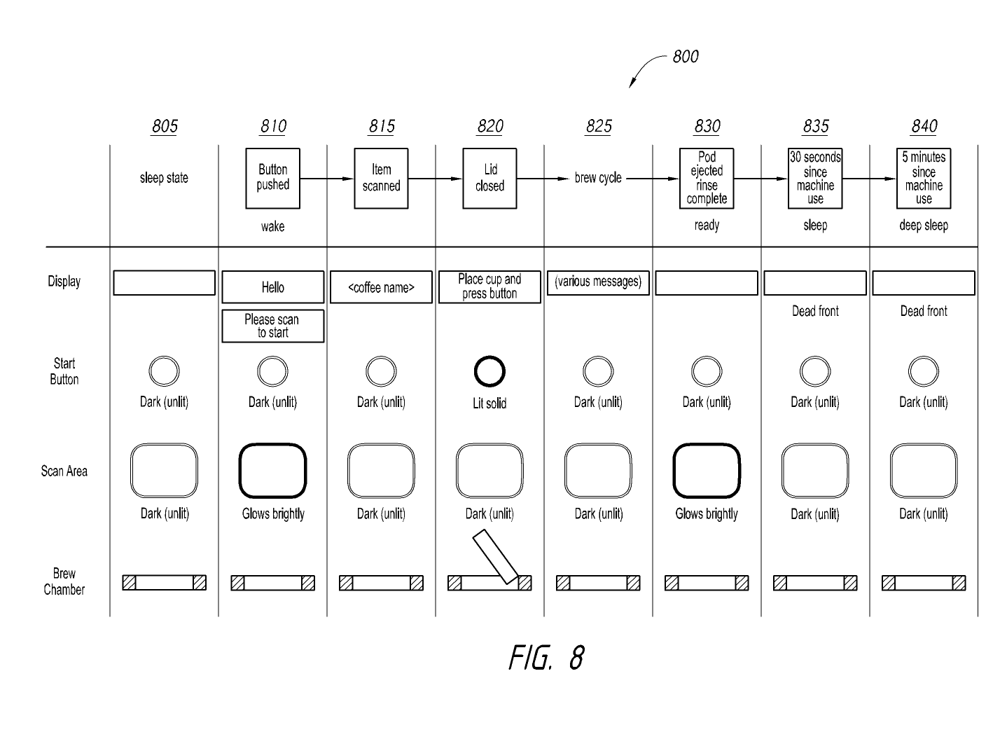

A window of the reader 155 may be illuminated to indicate to the user to bring the code or tag in close proximity to the reader 155 so that the beverage preparation machine 100 can determine the recipe (including beverage type) for the desired beverage. The start button 160A may be illuminated after the reader 155 has received the information from the code or tag to indicate to the user to insert the cartridge and press the start button 160A to begin preparation of the beverage. The hot water button 160B may be illuminated to instruct the user that hot water may be dispensed if desired or required. Although the outer perimeter of the user-actuatable buttons or reader window are shown as being illuminated, the entire button or window may be illuminated or lit in alternative embodiments. The illumination may accompany textual instructions on the display portion 125. Additional details regarding user prompts or indications will be further described below in connection with FIGS. 8-10.

### III. Coding Implementations

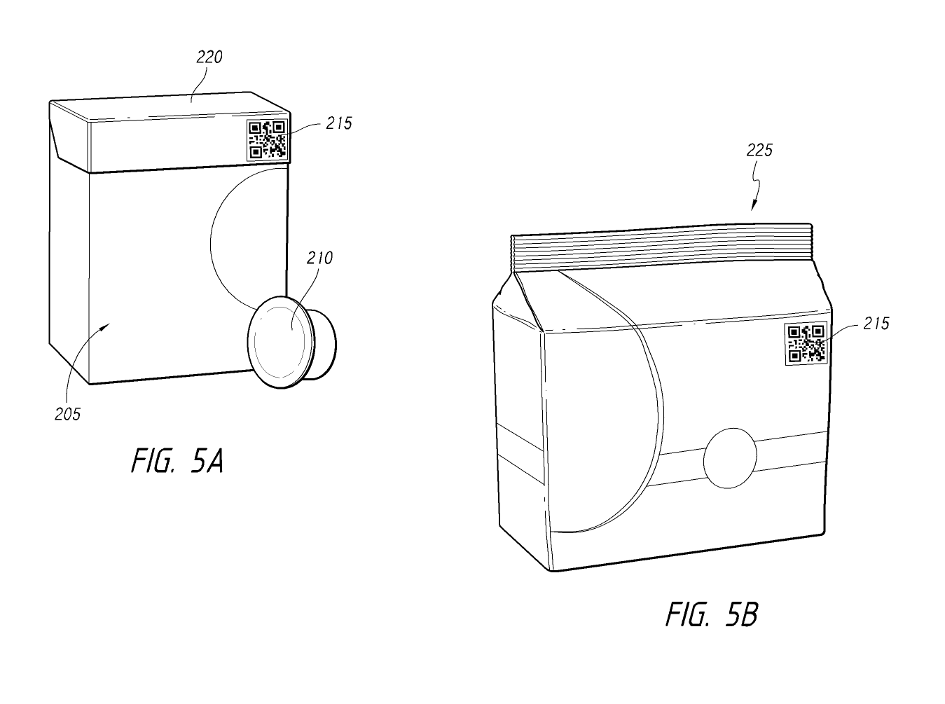

FIGS. 5A and 5B illustrate embodiments of packaging 205, 225 for single-serve cartridges 210 to be used with the beverage preparation machine 100. The illustrated packages have a 2D code 215 printed on an external surface of the packaging. FIG. 5A illustrates a box or carton packaging 205 having a lid portion 220. The 2D code 215 may be printed on the lid portion 220 or any other portion of the packaging independent of the cartridges stored therein. FIG. 5B illustrates a bag or pouch packaging 225. The 2D code 215 may be located on the front, back, side, top or bottom of the packaging 225. In some embodiments, the 2D code 215 of the packaging 205, 225 is brought into close proximity with the reader 155 so that the beverage preparation machine 100 can read the 2D code 215 to determine the recipe (including beverage type) for the single-serve beverage cartridges within the packaging. As shown in FIGS. 5A and 5B, the 2D code 215 is on the overall packaging and not on the individual single-serve cartridges; however, in other embodiments, the 2D code 215 or other code or tag may be provided on each of the individual single-serve beverage cartridges within the packaging. In one implementation, each single-serve cartridge is individually wrapped in a wrapper or other packaging that includes a code or tag indicative of a recipe. In one implementation, two, three, or more single-serve cartridges are wrapped in a wrapper or other packaging that includes a code or tag indicative of a recipe. The single-serve cartridges may include liquid contents (e.g., liquid coffee, liquid dairy, fruit concentrate, soup concentrate, etc.) or dry contents (such as coffee grounds, instant coffee, dairy powder, tea leaves, dried fruit, etc.).

The 2D code 215 or other code or tag may include information that can be used by the beverage preparation machine 100 to prepare the appropriate beverage based on the single-serve cartridge previously inserted or shortly to be inserted into the beverage preparation machine 100 by a user. For example, the code or tag may include recipe information, such as type of beverage (e.g., brewed coffee, espresso, tea, hot cocoa, latte, fruit juice, soup, broth, etc.), water temperature, amount of water, time information (e.g., brew time, shot time, infusion time, froth time, extraction time, steep time), whether or not a pre-infusion step is required, and/or whether multiple cartridges are required to prepare the beverage (e.g., a coffee cartridge and a milk cartridge). The code or tag may also include information that can be used to determine the language to be used for the display, as well as text to be displayed on the display portion 125 associated with the beverage (such as the name of the beverage and any flavor notes associated with the beverage).

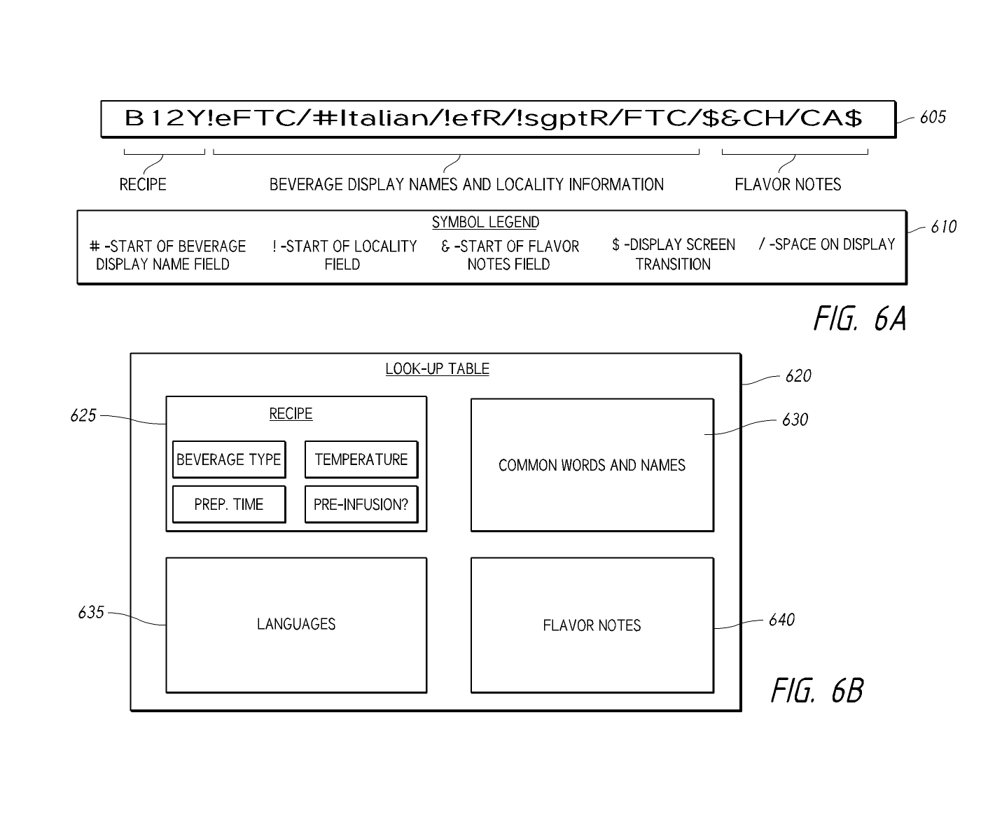

FIG. 6A shows an embodiment of content 605 that can be encoded on or otherwise included in the 2D code 215. The content 605 provided by the 2D code 215 may include recipe information, beverage display names, locality information, and/or flavor notes. As shown in the symbol legend 610, symbols may be used to assist the beverage preparation machine 100 (for example, the reader 155 or a controller) in parsing the information or content provided by the 2D code 215.

Referring to FIG. 6B, the beverage preparation machine 100 may include a look-up table or other data structure 620 that may be accessed by a controller (e.g., processor) of the beverage preparation machine 100 to interpret the content 605 provided by the 2D code 215 to determine the recipe for the desired beverage, language information, display information or other instructions. Because the 2D code may be limited to a certain number of characters to be encoded, use of the lookup table 620 may advantageously allow codes, symbols, letters, or shortened strings to be used within the content 605 to enable more information to be provided in the content 605.

For example, to reduce the amount of characters within the 2D code 215 related to the recipe information, the recipe portion of the content 605 can be limited to four alphanumeric characters or symbols, with each character or symbol correlating to a different recipe component or instruction. The lookup table 620 may include entries related to recipe information 625 that correspond to different recipe options. For example, the recipe information 625 can include beverage type (e.g., brewed coffee, espresso, and tea), water temperature, preparation time, and whether or not there is a pre-infusion required for the beverage preparation.

For embodiments where four alphanumeric characters or symbols are used, the first character can include a letter to identify a beverage type in the lookup table 620. As one example, the beverage types may include brewed coffee, espresso and tea and the letters corresponding to each beverage type may be “B,” “E” and “T,” respectively. Characters or symbols (e.g., numbers or letters) can also be provided in the recipe portion of the content 605 to indicate the water temperature, preparation time (e.g., brew, infusion or shot time) and whether a pre-infusion is required. In the illustrated embodiment, numbers are used for the water temperature and preparation time, and a Y or N is used for whether a pre-infusion is required. Other implementations may be used as desired or required.

The lookup table 620 may also include entries corresponding to common words and names 630 so that abbreviations or symbols or characters can be used in the content 605. Entries corresponding to different languages 635 may also be included in the lookup table 620. The display may be tailored to the language of a particular locality as determined from the content 605 of the 2D code. The lookup table 620 may also include entries corresponding to flavor notes (e.g., caramel, coconut, hazelnut, chocolate, vanilla, etc.) associated with the beverage. These flavor or tasting notes may be displayed during preparation of the beverage.

### IV. Multi-Chambered Basket Assemblies

In some embodiments, the beverage preparation machine 100 comprises multiple baskets or chambers, or a multi-chambered basket assembly (e.g., a double-sided brew basket). For example, a first brew basket or first side of a double-sided brew basket may be used for espresso-type beverages or short beverages and a second brew basket or second side of a double-sided brew basket may be used for brewed coffee beverages or long beverages. If a multi-chambered basket unit or assembly is present, the basket unit or assembly may be rotatable so that the different baskets or chambers can be selectively presented and/or accessed. In some embodiments, a brew basket may be used for coffee and an extraction chamber may be used for extracting or steeping tea. The brew basket or extraction chamber to be presented to receive the single-serve cartridge from the user may be determined from the 2D code 215. In some embodiments, the brew basket will be determined by the beverage type identified from recipe information of the content 605 of the 2D code 215.

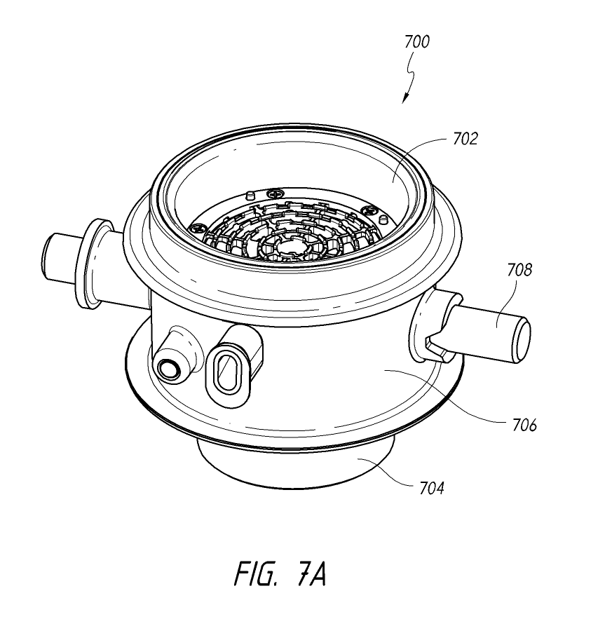

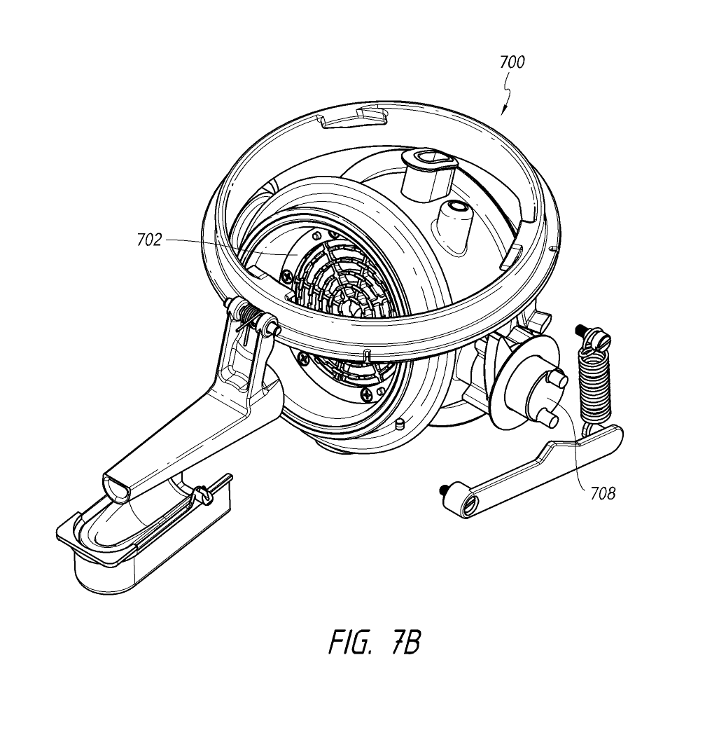

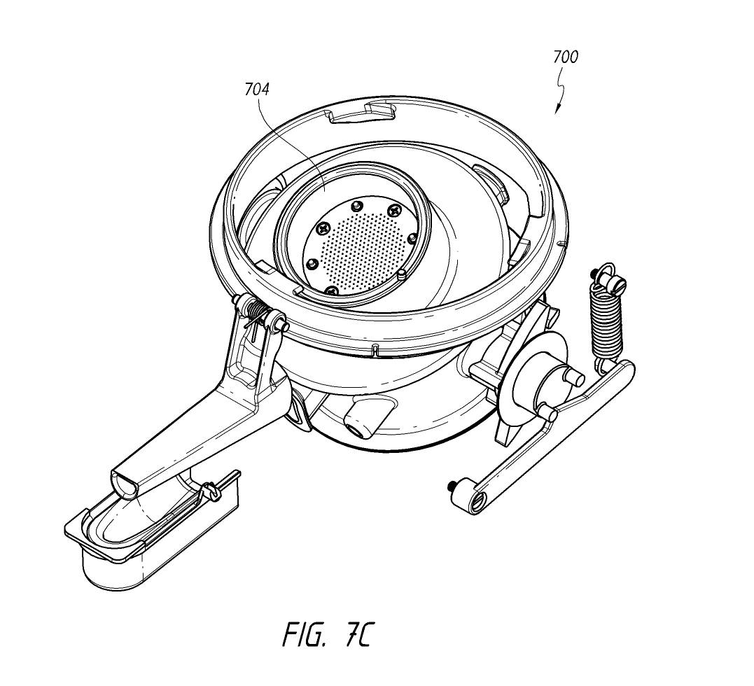

FIG. 7A illustrates a perspective view of an embodiment of a multi-chambered basket unit or assembly 700. In some embodiments, the basket unit 700 includes a body portion with a first cartridge-receiving chamber 702 and a second cartridge-receiving chamber 704. As shown, the first chamber 702 can be located on a first side of the basket unit 700 and the second chamber 704 is disposed on a second opposite side of the basket unit 700. For example, the first chamber 702 and the second chamber 704 can be positioned on generally opposite sides of the basket unit 700. Certain embodiments of the basket unit 700 have additional chambers, such as third, fourth, fifth, sixth, or otherwise chambers.

In some implementations, the basket unit 700 includes a body portion 706. The illustrated body portion 706 has a generally cylindrical shape, though many other shapes are contemplated as well. In some embodiments, the first chamber 702 is positioned at a first end of the generally cylindrical shape and the second chamber 704 is positioned at a second end of the generally cylindrical shape. In some embodiments, the first and/or second chambers 702, 704 protrude into the body portion 706 (e.g., are recessed within).

In various embodiments, the first and second chamber 702, 704 are configured to receive different types of cartridges. For example, the first chamber 702 can be configured to receive a first type of cartridge with a first size and/or shape and the second chamber 704 can be configured to receive a second type of cartridge a second size and/or shape. In some embodiments, the first type of cartridge is for the production of a brewed coffee beverage and the second type of cartridge is for the production of an espresso coffee beverage (e.g., latte, macchiato, cappuccino, espresso shot, etc.). The different chambers may have different configurations and structural elements depending on the type of beverage to be prepared therein (e.g., filters, straining elements, slits, apertures, valves, etc.). In some implementations, the different chambers may be configured to operate under different (e.g., high and low) pressures. For example, a chamber or basket configured to prepare espresso beverages may operate at a higher pressure than a chamber or basket configured to prepare brewed coffee beverages.

FIGS. 7B and 7C illustrate perspective views of the multi-chambered basket unit 700 of FIG. 7A at various stages of rotating operations. According to various implementations, the multi-chambered basket unit 700 is configured to rotate about a central axle 708. FIG. 7B illustrates the multi-chambered basket unit 700 in the process of rotating to present the first chamber 702 in a position for receiving a first cartridge. In some implementations, a “ready” position for insertion of a cartridge is a vertical position with the chamber to receive the cartridge on top and facing upward and the other chamber facing downward. The first chamber 702 may be configured to prepare brewed coffee beverages. As shown, a chamber for preparing brewed coffee beverages may include relatively large exit apertures or filter elements due to the reduced level of pressure required to prepare brewed coffee beverages. FIG. 7C illustrates the multi-chambered basket unit 700 in the process of rotating to present the second chamber 704 in a position for receiving a second cartridge. The second chamber 704 may be configured to prepare espresso coffee beverages. As shown, the espresso coffee chamber or basket may include very small exit apertures configured to induce a much higher pressure within the chamber.

As discussed above, the determination of the chamber to be selectively presented to receive a cartridge may be based on a beverage type identified from a code or tag corresponding to the cartridge. The code or tag may be identified by a reader or scanner (e.g., reader 155) of the beverage preparation machine. The code or tag may be disposed on the cartridge or on packaging associated with the cartridge (e.g., packaging that surrounds one or more cartridges for shipping or delivery). If the beverage type is identified as a first beverage type, the first chamber 702 may be rotated or otherwise caused to be presented to a receiving area to receive a single-serve beverage cartridge of the first beverage type. If the beverage type is identified as a second beverage type, the second chamber is rotated or otherwise caused to be presented to the receiving area to receive a single-serve beverage cartridge of the second beverage type.

Additional details regarding the multi-chambered basket unit or assembly 700 are disclosed in U.S. application Ser. No. ______, filed on the same day as the present application, entitled “BEVERAGE PRODUCTION MACHINES AND METHODS WITH MULTI-CHAMBERED BASKET UNITS” [ATTY DOCKET NO: SBUX1.295A], the entirety of which is incorporated by reference.

### V. Machine Operation

Turning to FIG. 8, a control diagram 800 illustrating overall operation of the beverage preparation machine 100, according to an embodiment of the invention, is provided. The control diagram 800 illustrates the operation of various components of the beverage preparation machine 100 at different states of a beverage preparation process. The various components illustrated are the display, the start button, the scan area of the reader and the brew chamber. The execution of the states and actions described herein may be controlled by one or more processors or controllers of the beverage preparation machine 100.

The first state 805 corresponds to a sleep state. In the sleep state, the display is blank, the start button is dark or unlit, the scan area is unlit and the brew chamber is empty. When the beverage preparation machine 100 is turned on (e.g., by a user pressing a main power button), the beverage preparation machine 100 enters a wake state 810. The display portion may display a greeting for a predetermined amount of time and then an instruction indicating to the user that a code or tag must be scanned by the reader 155 to initiate the beverage preparation process. The scan area or a perimeter of the scan area of the reader 155 may be illuminated to provide a visual indication to the user to scan the code or tag corresponding to the desired beverage.

After the code or tag is read by the reader 155 (from the packaging containing the cartridge or the cartridge itself), the beverage preparation process proceeds to state 815. At state 815, the display portion 125 displays the name of the beverage based on information received from the code or tag and the scan area is no longer illuminated. At this stage, the lid 150 of the beverage machine 100 may be opened (either automatically or manually) and the user may be instructed or may simply know to insert a single-serve cartridge into the brew chamber and close the lid 150. For embodiments of machines with multiple chambers or baskets (e.g., one low-pressure basket and one high-pressure basket), the determination of which basket to present may be determined from the information contained on or within the code or tag, as described above in connection with FIGS. 5A-7C. For example, if the beverage is determined to be a brewed coffee or “low pressure” beverage, the low-pressure brew basket may be presented for insertion of a brewed coffee cartridge. If the beverage is determined to be an espresso or “high pressure” beverage, the high-pressure basket may be presented for insertion of an espresso cartridge. As described in more detail above in connection with FIGS. 7A-7C, for a machine with a double-sided basket assembly, if the beverage is determined to be a brewed coffee beverage, the side of the basket assembly configured for preparing brewed coffee beverages at low pressure may be rotated or otherwise manipulated so that it is presented in a position to receive a brewed coffee cartridge (e.g., in an upward-facing position just below the lid). If the beverage is determined to be an espresso coffee beverage, the side of the basket assembly configured for preparing beverages at high pressure may be rotated or otherwise manipulated so that it is presented in a position to receive an espresso coffee cartridge (e.g., in an upward-facing position just below the lid).

Once the lid 150 is closed, the beverage preparation process may proceed to state 820, where the user is instructed to place a cup or other container in the dispensing portion 130 and press the start button 160A, which may also be partially or fully illuminated to provide a visual indication. Once the start button 160A has been pressed, the brew or extraction cycle begins at state 825. Various status messages (e.g., status bars and/or percentages) or flavor notes may be displayed on the display during the cycle. After the cycle is complete, the beverage preparation process proceeds to state 830, where the cartridge is ejected from the brew chamber and a rinse cycle is performed. The scan area may then be partially or fully illuminated again to indicate that the beverage preparation machine 100 is ready to prepare another beverage, as in the wake state 810. In some embodiments, the beverage preparation machine 100 is configured to store the most recently-used recipe in memory and use the most recently-used recipe to prepare the next beverage if a code or tag is not presented for reading by the reader 155 prior to the start button 160A being pressed by a user. In other embodiments, the beverage preparation machine 100 requires scanning of a code or tag prior to preparation of every beverage or prior to insertion of every cartridge.

After a predetermined amount of time (e.g., 30 seconds) without a user either scanning a new code or tag or otherwise interfacing with the beverage preparation machine 100, the beverage preparation machine 100 may enter a sleep state 835. In some embodiments, after a second predetermined amount of time (e.g., 5 minutes), a deep sleep state 840 may be entered to reduce power consumption. The beverage preparation machine 100 may be battery-operated, inductively charged, or connected to a standard electrical outlet with a plug.

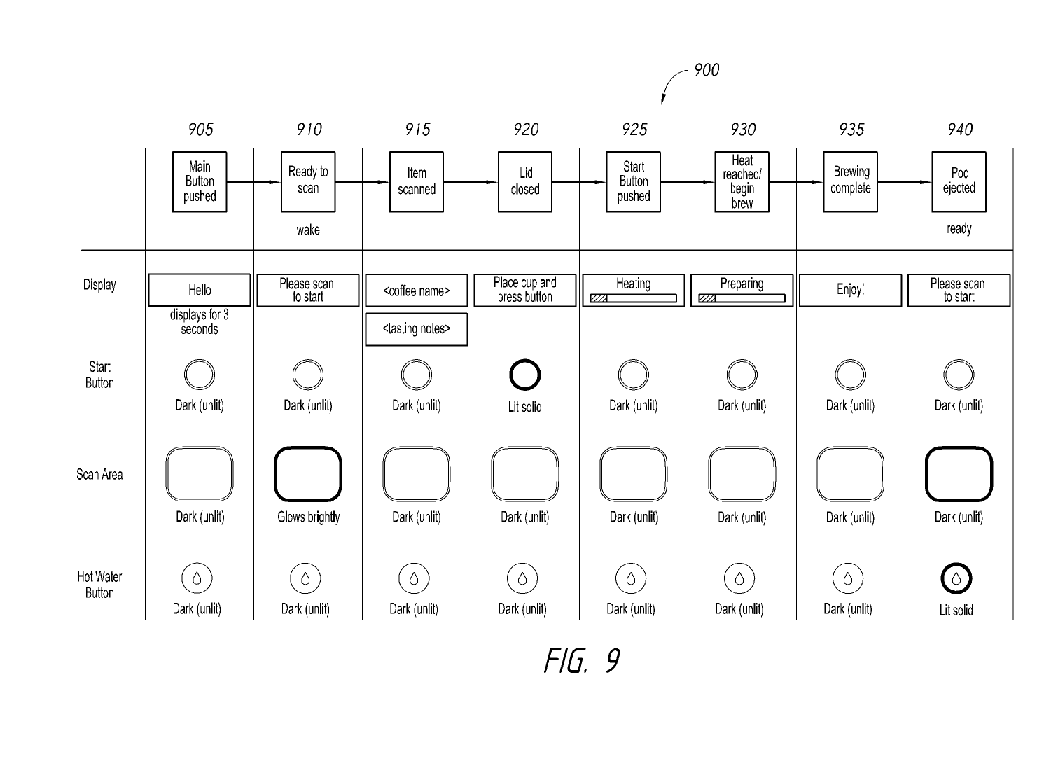

FIG. 9 is a control diagram illustrating states involved in preparation of a single-serve brewed coffee beverage by the beverage preparation machine 100, according to an embodiment of the invention. The control diagram 900 illustrates the operation of various components of the beverage preparation machine 100 at different states of the single-serve brewed coffee preparation process. The various components illustrated are the display 125, the start button 160A, the scan area of the reader 155 and the hot water button 160B. The execution of the states and actions described herein may be controlled by one or more processors or controllers of the beverage preparation machine 100.

The first state corresponds to an initial wake state 905 after the beverage preparation machine 100 is powered on. The display portion may display a greeting in the wake state 905 for a predetermined amount of time. Once the beverage preparation machine 100 is ready for a code or tag to be read by the reader 155, a scan state 910 is entered, in which a textual instruction may be displayed on the display portion and the scan area or a perimeter or other portion of the scan area may be partially or fully illuminated. After the code or tag is read or scanned, a cartridge insertion state 915 is entered. The display portion displays the name of the coffee and optionally any flavor or tasting notes based on the information received from the code or tag via the reader 155. The lid is also opened (either automatically or manually) and the single-serve cartridge is inserted into the brew chamber or basket configured for brewing coffee beverages.

For embodiments of machines with multiple chambers or baskets (e.g., one low-pressure basket and one high-pressure basket), the beverage preparation machine 100 determines that the brew basket or low-pressure basket should be presented for insertion of the brewed coffee beverage cartridge based on information or content provided by the code or tag, as described above in connection with FIGS. 5A-7C. For example, in a machine with a double-sided basket assembly (as shown and described in connection with FIGS. 7A-7C), the brew basket may be rotated or otherwise manipulated so that it is presented in a position to receive the brewed coffee cartridge (e.g., in an upward-facing position just below the lid).

After the lid is closed, a waiting state 920 is entered in which the beverage preparation machine 100 instructs the user to place a cup in the dispensing portion 130 and press the start button 160A (e.g., on the display portion 125). The start button 160A may also be illuminated to provide a visual indication to the user.

After the start button 160A is pressed, the beverage preparation machine 100 enters a heating state 925 in which an appropriate amount of water is heated to a temperature determined from the recipe received from the code or tag. When the proper temperature has been reached, a brew state 930 is entered and the beverage preparation machine 100 completes the preparation of the coffee beverage and dispenses the prepared beverage into the cup or other receptacle placed in the dispensing portion 130. Various status indications may be displayed during the heating state 925 and the brewing state 930 as shown in FIG. 9. Once the brewing cycle is complete, an ejection and/or cleaning state 935 is entered in which the beverage preparation machine 100 ejects the cartridge and/or cleans or rinses the brew chamber. For example, for a machine with a double-sided basket assembly, the side of the double-sided brew basket containing the cartridge may be rotated in such a manner so as to eject the cartridge from the brew basket and into a waste chamber and a rinsing of the brew basket may be performed to remove any lingering particulates or residue. The beverage preparation machine 100 then returns to the scan state 910.

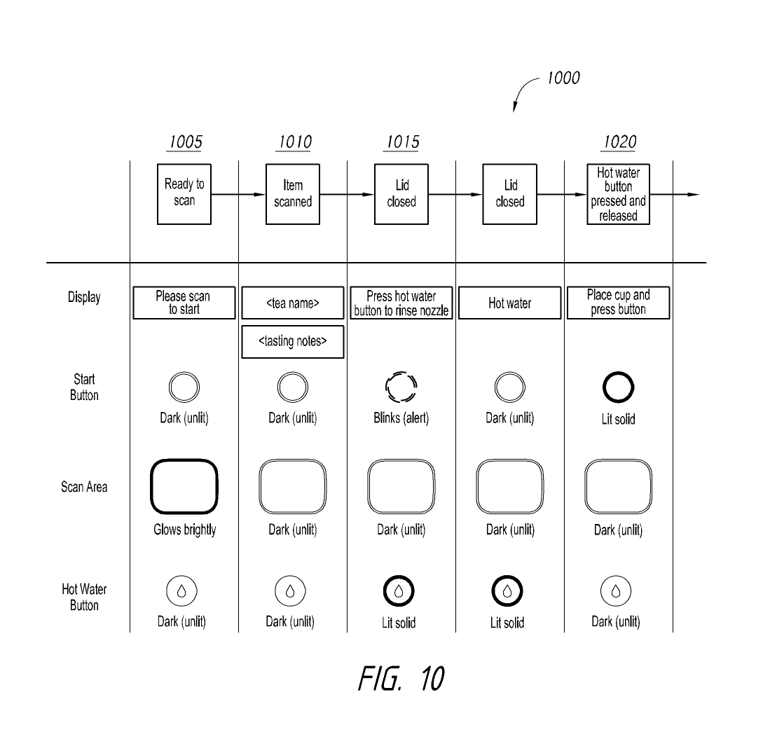

FIG. 10 is a control diagram illustrating states involved in preparation of a single-serve tea beverage by the beverage preparation machine 100. The execution of the states and actions described herein may be controlled by one or more processors or controllers of the beverage preparation machine 100. Similar to the processes described above, during a scan state 1005, the display portion 125 may display a textual instruction to the user to scan a code and the scan area of the reader 155 may be illuminated to provide a visual indication. After the reader 155 has read or scanned the code, the name of the tea and any optional flavor or tasting notes may be displayed on the display portion 125 at stage 1010. The lid 150 may also be opened and a single-serve tea pod inserted into a preparation chamber.

In embodiments of machines having a multi-chambered basket assembly, the determination of which basket to present may be determined from the information contained on or within the code or tag, as described above in connection with FIGS. 5A-7C. The determination of the beverage as a tea from the information provided by the code or tag may cause a basket or other preparation unit configured for preparing tea to be presented for insertion of the single-serve tea pod. In embodiments of machines having a double-sided basket assembly with a high pressure basket and a low pressure basket on opposite sides, one of the baskets may be used to prepare tea beverages. In one embodiment, a valve or seal may be activated to prevent dispensing of the beverage until a predetermined steeping, infusion, or extraction time has been reached for preparing the tea beverage. In other embodiments, a separate basket or preparation unit of a multi-chambered basket assembly that is specifically configured for preparation of tea beverages from tea pods, pads or cartridges may be used.

After the lid 150 is closed, the beverage preparation machine 100 may enter a rinsing state 1015. The start button 160A may blink or provide another visual indication and the hot water button 160B may be illuminated to provide a visual indication to the user to press the hot water button 160B to rinse the nozzle. A textual instruction may also be displayed on the display portion 125. After the nozzle has been rinsed with hot water, a tea preparation state 1020 is entered in which the user is instructed to place a cup within the dispensing area 130 and press the start button 160A. The start button 160A may optionally be illuminated to provide a visual indication to the user.

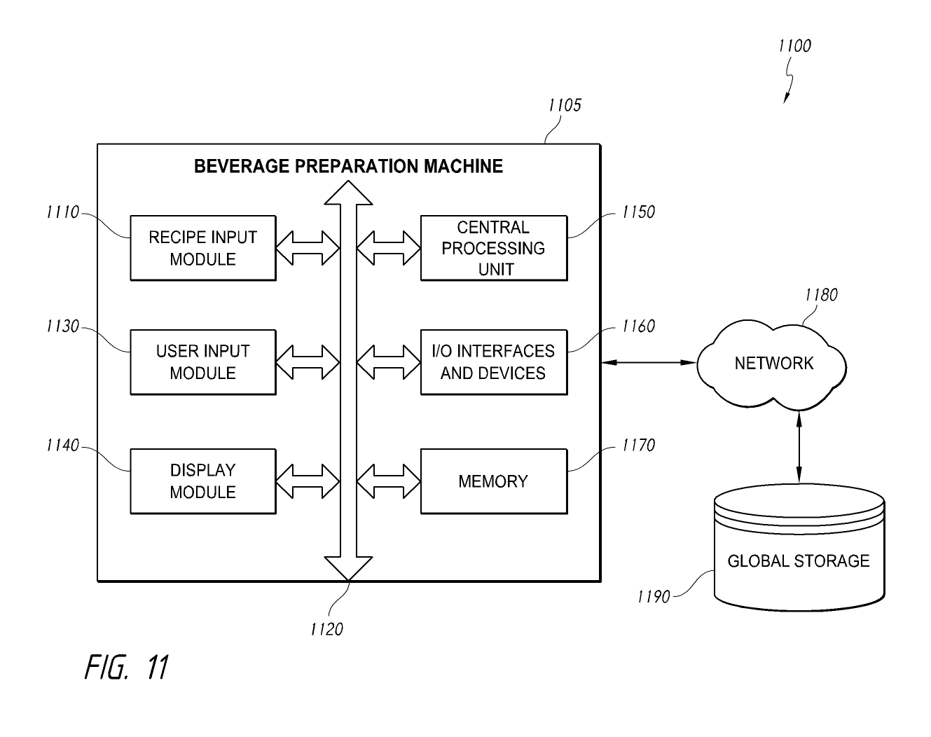

FIG. 11 is a block system diagram illustrating a general architecture of a beverage preparation system 1100. The beverage preparation system 1100 may include a beverage preparation machine 1105. The beverage preparation machine 1105 may include a recipe input module 1110, a user input module 1130, a display module 1140, a processor or controller 1150, one or more input/output interfaces and devices 1160 and memory 1170. The components of the beverage preparation machine 1105 may communicate with each other via a bus or other communication line 1120. The beverage preparation machine 1105 may optionally be communicatively coupled (via a wired or wireless connection) to a communications network 1180. The communications network 1180 may be communicatively coupled to a global storage unit 1190 stored on one or more servers or computing devices. The global storage unit 1190 may be configured to store information obtained from the beverage preparation machine 1105 or information that may be used to update the look-up table 620 stored within memory 1170 of the beverage preparation machine 1105. The communications network 1180 may be used, for example, to receive software updates or other information.

The recipe input module 1110, upon execution, may be configured to read, decode and/or interpret a code placed in close proximity to the reader 155 and to determine a recipe from the code. The reader input module 1110, upon execution, may also be configured to interrogate or otherwise receive information from an RFID tag or a NFC tag. The user input module 1130 may be configured to, upon execution, detect inputs from the user-actuatable inputs 160. The display module 1140 may be configured to, upon execution, operate the display portion 125 of the beverage preparation machine 1105. The display module 1140 may be associated with any number of visual or tactile interfaces incorporating any of a number of active or passive display technologies (e.g., electronic-ink, LCD, LED or OLED, CRT, 3D, DLP projection, etc.) or technologies for the display of Braille or other tactile information. The recipe input module 1110, the user input module 1130 and the display module 1140 may be executed by the controller 1150, which may be a specific-purpose processor. In some embodiments, the various modules comprise hardware components.

The controller 1150 may be any hardware computing device, such as a processor or microcontroller. The controller 1150 may be implemented using a single computing device or multiple computing devices. The input/output interfaces and devices 1160 may include a network interface to provide connectivity to the network 1180 or computing systems. The input can be received via one or more input ports, including, but not limited to, Bluetooth or other wireless links, optical ports, USB ports, and/or the like. The input/output device interfaces and devices 1160 may also provide output via one or more output devices, including, but not limited to, one or more speakers or any of a variety of digital or analog audio capable output ports, including, but not limited to, headphone jacks, XLR jacks, stereo jacks, Bluetooth links, RCA jacks, optical ports or USB ports.

The controller 1150 may also communicate to and from memory 1170. The memory 1170 contains computer program instructions (organized into modules) that the controller 1150 executes in order to implement one or more embodiments of the present disclosure. In some embodiments, the modules illustrated in FIG. 11 reside in memory 1170. In one embodiment, the look-up table 620 resides in memory 1170. The memory 1170 generally includes RAM, ROM and/or other persistent or non-transitory computer-readable media. The memory 1170 may store an operating system that provides computer program instructions for use by the controller 1150 in the general administration and operation of the controller 1150. The memory 1170 may further include other information for implementing aspects of the present disclosure. In addition, memory 1170 may include or communicate with the global storage 1190.

### VI. Terminology

As used herein, the term “beverage,” in addition to having its ordinary meaning, can include, among other things, any liquid or substantially liquid substance or product having a flowing quality such as juices, coffee beverages, teas, frozen yogurt, beer, wine, cocktails, liqueurs, spirits, cider, soft drinks, flavored water, energy drinks, soups, broths, combinations of the same, or the like. The term “cartridge” as used herein shall be given its ordinary and customary meaning, and shall include, without limitation, cartridges, capsules, cups, pods, pucks, pads, and the like, whether or not such cartridge is capable of being pierced or otherwise ruptured in order to form an inlet and/or outlet for the cartridge.

Although certain embodiments have been described herein with respect to coffee, the cartridges described herein can include particulate materials or components for producing many other types of beverages, such as a chocolate based product (e.g., hot cocoa), tea, juice, soups, broths, and other beverages. Further, although some embodiments have been disclosed in which liquid is introduced into the cartridge, the introduction of other phases is contemplated. For example, in some embodiments, steam or a combination of steam and liquid water is introduced into the cartridge. Additionally, although certain embodiments have been disclosed that include a single beverage component or precursor, the term “beverage component or precursor” is not limited to only a single component. Rather, the beverage component or precursor can comprise one component (e.g., coffee) or a plurality of components (e.g., coffee and a sweetener).

Although this disclosure describes certain embodiments and examples of beverage preparations machines and beverage preparation chambers or baskets, it will be understood by those skilled in the art that many aspects of the methods and devices shown and described in the present disclosure may be differently combined and/or modified to form still further embodiments or acceptable examples. All such modifications and variations are intended to be included herein within the scope of this disclosure. Indeed, a wide variety of designs and approaches are possible and are within the scope of this disclosure. No feature, structure, or step disclosed herein is essential or indispensible. Moreover, while illustrative embodiments have been described herein, the scope of any and all embodiments having equivalent elements, modifications, omissions, combinations (e.g., of aspects across various embodiments), adaptations and/or alterations as would be appreciated by those in the art based on the present disclosure.

Furthermore, certain features that are described in this disclosure in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations, one or more features from a claimed combination can, in some cases, be excised from the combination, and the combination may be claimed as a subcombination or variation of a sub combination.

Moreover, while operations may be depicted in the drawings or described in the specification in a particular order, such operations need not be performed in the particular order shown or in sequential order, or that all operations be performed, to achieve desirable results. Other operations that are not depicted or described can be incorporated in the example methods and processes. For example, one or more additional operations can be performed before, after, simultaneously, or between any of the described operations. Further, the operations may be rearranged or reordered in other implementations. Also, the separation of various system components in the implementations described above should not be understood as requiring such separation in all implementations, and it should be understood that the described components and systems can generally be integrated together in a single product or packaged into multiple products.

For purposes of this disclosure, certain aspects, advantages, and novel features are described herein. Not necessarily all such advantages may be achieved in accordance with any particular embodiment. Thus, for example, those skilled in the art will recognize that the disclosure may be embodied or carried out in a manner that achieves one advantage or a group of advantages as taught herein without necessarily achieving other advantages as may be taught or suggested herein.

Conditional language, such as “can,” “could,” “might,” or “may,” unless specifically stated otherwise, or otherwise understood within the context as used, is generally intended to convey that certain embodiments include, while other embodiments do not include, certain features, elements, and/or steps. Thus, such conditional language is not generally intended to imply that features, elements, and/or steps are in any way required for one or more embodiments or that one or more embodiments necessarily include logic for deciding, with or without user input or prompting, whether these features, elements, and/or steps are included or are to be performed in any particular embodiment.

Conjunctive language such as the phrase “at least one of X, Y, and Z,” unless specifically stated otherwise, is otherwise understood with the context as used in general to convey that an item, term, etc. may be either X, Y, or Z. Thus, such conjunctive language is not generally intended to imply that certain embodiments require the presence of at least one of X, at least one of Y, and at least one of Z.

Unless otherwise explicitly stated, articles such as ‘a’ or ‘an’ should generally be interpreted to include one or more described items. Accordingly, phrases such as “a device configured to” are intended to include one or more recited devices. Such one or more recited devices can also be collectively configured to carry out the stated recitations. For example, “a processor configured to carry out recitations A, B and C” can include a first processor configured to carry out recitation A working in conjunction with a second processor configured to carry out recitations B and C.

Language of degree used herein, such as the terms “approximately,” “about,” “generally,” and “substantially” as used herein represent a value, amount, or characteristic close to the stated value, amount, or characteristic that still performs a desired function or achieves a desired result. For example, the terms “approximately,” “about,” “generally,” and “substantially” may refer to an amount that is within less than 10% of, within less than 5% of, within less than 1% of, within less than 0.1% of, and within less than 0.01% of the stated amount. As another example, in certain embodiments, the terms “generally parallel” and “substantially parallel” refer to a value, amount, or characteristic that departs from exactly parallel by less than or equal to 15 degrees, 10 degrees, 5 degrees, 3 degrees, 1 degree, 0.1 degree, or otherwise.

Some embodiments have been described in connection with the accompanying drawings. However, the figures are not drawn to scale. Distances, angles, etc. are merely illustrative and do not necessarily bear an exact relationship to actual dimensions and layout of the devices illustrated. Components can be added, removed, and/or rearranged. Further, the disclosure herein of any particular feature, aspect, method, property, characteristic, quality, attribute, element, or the like in connection with various embodiments can be used in all other embodiments set forth herein. Additionally, it will be recognized that any methods described herein may be practiced using any device suitable for performing the recited steps.

All of the processes described herein may be embodied in, and fully automated via, software code modules executed by one or more general purpose or specialized computers or processors. The code modules may be stored in any type of computer-readable medium or other computer storage device. Some or all the methods may alternatively be embodied in specialized computer hardware. A software module can reside in RAM memory, flash memory, ROM memory, EPROM memory, EEPROM memory, registers, hard disk, a removable disk, a CD-ROM, or any other form of non-transitory computer-readable storage medium known in the art. An exemplary storage medium can be coupled to the processor such that the processor can read information from, and write information to, the storage medium. In the alternative, the storage medium can be integral to the processor. The processor and the storage medium can reside in an ASIC. The ASIC can reside in a user terminal. In the alternative, the processor and the storage medium can reside as discrete components in a user terminal.

Any process descriptions, elements or blocks in the flow diagrams described herein and/or depicted in the attached figures should be understood as potentially representing modules, segments, or portions of code which include one or more executable instructions for implementing specific logical functions or elements in the process. Alternate implementations are included within the scope of the embodiments described herein in which elements or functions may be deleted, executed out of order from that shown, or discussed, including substantially concurrently or in reverse order, depending on the functionality involved as would be understood by those skilled in the art. Moreover, in certain embodiments, acts or events can be performed concurrently, e.g., through multi-threaded processing, interrupt processing, or multiple processors or processor cores or on other parallel architectures, rather than sequentially. In addition, different tasks or processes can be performed by different machines and/or computing systems that can function together. Execution in a cloud computing environment in some embodiments supports a multiplicity of conditions to be computed contemporaneously.

The various illustrative logical blocks and modules described in connection with the embodiments disclosed herein can be implemented or performed by a machine, such as a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor can be a microprocessor, but in the alternative, the processor can be a controller, microcontroller, or state machine, combinations of the same, or the like. A processor can also be implemented as a combination of computing devices, e.g., a combination of a DSP and a microprocessor, a plurality of microprocessors, one or more microprocessors in conjunction with a DSP core, or any other such configuration. A computing environment can include any type of computer system, including, but not limited to, a computer system based on a microprocessor, a mainframe computer, a digital signal processor, a portable computing device, a personal organizer, a device controller, and a computational engine within an appliance, to name a few.

It should be emphasized that many variations and modifications may be made to the above-described embodiments, the elements of which are to be understood as being among other acceptable examples. All such modifications and variations are intended to be included herein within the scope of this disclosure and protected by the following claims.

What is claimed is:

1. A single-serve beverage preparation device comprising:
a multi-chambered basket unit comprising a first cartridge-receiving chamber and a second cartridge-receiving chamber,
wherein the first cartridge-receiving chamber is configured to receive a first cartridge of a first beverage type and wherein the second cartridge-receiving chamber is configured to receive a second cartridge of a second beverage type;
a two dimensional (2D) code reader configured to read a 2D code associated with a single-serve beverage cartridge containing one or more beverage ingredients; and
a controller configured to determine a beverage type of the single-serve beverage cartridge from the 2D code and to cause the multi-chambered basket unit to present the cartridge-receiving chamber corresponding to the determined beverage type in a position to receive the single-serve beverage cartridge.

2. The device of claim 1, wherein the multi-chambered basket unit is configured to present the cartridge-receiving chamber by rotating about an axle.

3. The device of claim 1, wherein the first beverage type is a brewed coffee and wherein the second beverage type is an espresso coffee.

4. The device of claim 1, wherein the 2D code is located on packaging of the single-serve beverage cartridge in which the single-serve beverage cartridge is contained.

5. The device of claim 1, wherein the 2D code is located on a portion of the single-serve beverage cartridge.

6. The device of claim 1, wherein the multi-chambered basket unit comprises a double-sided brew basket.

7. The device of claim 1, wherein the one or more beverage ingredients comprise coffee grounds.

8. The device of claim 1, wherein the 2D code reader comprises a plurality of light emitting diodes and a camera module.

9. The device of claim 1, wherein the device further comprises a frother unit.

10. A device comprising:
a first cartridge-receiving chamber and a second cartridge-receiving chamber,
wherein the first cartridge-receiving chamber is configured to receive a first cartridge of a first type and wherein the second cartridge-receiving chamber is configured to receive a second cartridge of a second type;
a machine readable code reader configured to read an machine readable code associated with an insertable cartridge containing one or more ingredients; and
a controller configured to determine a type of the insertable cartridge from the machine readable code,
wherein, if the controller determines from the machine readable code that the type of the insertable cartridge is a first type, the controller is configured to cause the first cartridge-receiving chamber to be presented to receive the insertable cartridge, and
wherein, if the controller determines from the machine readable code that the type of the insertable beverage cartridge is a second type, the controller is configured to cause the second cartridge-receiving chamber to be presented to receive the insertable cartridge.

11. The device of claim 10, wherein the machine readable code comprises a bar code.

12. The device of claim 10, wherein the first type of cartridge is a low pressure cartridge and wherein the second type of cartridge is a high pressure cartridge.

13. The device of claim 10, wherein the machine readable code is located on packaging of the insertable cartridge that contains the insertable cartridge.

14. The device of claim 10, wherein the machine readable code is located on a portion of the insertable cartridge.

15. The device of claim 10, wherein the first cartridge-receiving chamber has a first size and wherein the second cartridge-receiving chamber has a second size, and wherein the second size is smaller than the first size.

16. A method of preparing beverages of a first beverage type and a second beverage type using a beverage preparation machine, the method comprising:
reading an information element associated with a first beverage cartridge of a first beverage type;
determining the first beverage type from the information element;
in response to determining the first beverage type from the information element code, causing a first cartridge-receiving chamber of a multi-chambered basket unit to be presented in a position to receive the first beverage cartridge of the first beverage type from a user of the beverage preparation machine;
preparing a first beverage using the first beverage cartridge;
reading an information element associated with a second beverage cartridge of a second beverage type;
determining the second beverage type from the information element;
in response to determining the second beverage type from the information element, causing a second cartridge-receiving chamber of a multi-chambered basket unit to be presented in a position to receive the second beverage cartridge of the second beverage type from the user; and
preparing a second beverage using the second beverage cartridge.

17. The method of claim 16, wherein the information element comprises at least one of a bar code, a radiofrequency identification tag or a near field communication tag.

18. The method of claim 16, wherein the information element is a bar code that comprises at least one of a one dimensional bar code or a two dimensional bar code.

19. The method of claim 16, wherein the multi-chambered basket unit comprises a double-sided brew basket.

20. The method of claim 18, wherein said determining the first beverage type from the bar code comprises accessing a look-up table based on an alphanumeric character determined from the bar code.

21. The method of claim 16, wherein said causing a first cartridge-receiving chamber of a multi-chambered basket unit to be presented in a position to receive the first beverage cartridge of the first beverage type comprises rotating the multi-chambered basket unit about an axle.
